(19) United States
(12) Patent Application Publication
(10) Pub. No.: US 2025/0100135 A1
(43) Pub. Date: Mar. 27, 2025

(54) ROBOT CONTROL POLICY

(71) Applicant: Mentee Robotics LTD., Herzliya (IL)

(72) Inventors: Shir GUR, Herzliya (IL); Tom SHENKAR, Herzliya (IL); Shahar LUTATI, Herzliya (IL)

(73) Assignee: Mentee Robotics LTD., Herzliya (IL)

(21) Appl. No.: 18/890,726

(22) Filed: Sep. 19, 2024

Related U.S. Application Data
(60) Provisional application No. 63/584,486, filed on Sep. 21, 2023.

(51) Int. Cl. B25J 9/16; G06N 3/008

(52) U.S. Cl. CPC B25J 9/163; B25J 9/1605; G06N 3/008; G05B 2219/32334

(57) ABSTRACT

There is provided a method for learning a bipedal robot control policy, the method includes (i) learning, by a processing circuit, an action-related corrective policy that once applied reduces a gap associated with an initial simulation state transition function and with a real world state transition function; and (ii) determining a control policy of the bipedal robot in a simulator, using the action-related corrective policy.

### CROSS REFERENCE

This application claims priority of U.S. provisional patent 63/584,586 filing date Sep. 21, 2023 which is incorporated herein in its entirety.

### BACKGROUND OF THE INVENTION

An interesting experiment to conduct is to try to walk using memorization. Using a walking policy, one can record the actions a bipedal robot makes. One can then reset the robot to the same initial pose and apply the recorded sequence of actions. When performing this experiment, the robot, as expected, falls after a few steps, since the system is inherently noisy and there is an accumulated drift.

A similar experiment can be conducted to evaluate the severity of the Sim2Real gap. A bipedal robot can walk in a simulator and the sequence of actions can be recorded. Then, this sequence is applied to the real robot, after it has been initialized appropriately to the initial pose of the simulation. This time, the robot falls almost immediately.

By comparing the outcome of the second experiment to the previous one, it becomes clear that the Sim2Real gap is much larger than the system noise. This gap is further verified by recording a real walking robot, initializing a virtual robot in the simulator to the initial state, and applying the recorded sequence. Again, the mimicking robot falls almost immediately. This evident gap is despite the advancement in simulator technology and making every effort to manufacture the parts accurately and to measure the properties of the various components of the robot precisely.

Given the severity of the Sim2Real Gap, a bipedal walking policy that is trained in a simulator and performs well in the world has to be extremely robust. This is encouraged, for example, by adding noise to both the actions and the states during training and also to the dynamics of the robot (masses, position of the center of mass, motor strength) and its environment (including ground friction and motor stiction).

Unavoidably, this robustness comes at the expense of other aspects of walking, such as the ability to follow commands instantly. As a result, the robot may have difficulties, for example, walking above a certain speed or making small human-like turns through the learned policy. On the other hand, randomization acts as a regularizing term, which can even enhance efficiency, agility, and naturalness by avoiding reliance on unstable solutions.

A simulator, viewed in abstract terms, is a transition from one state to the next, given an action. The policy suggests such an action and the transition occurs. The Sim2Real gap, viewed this way, means that the new state obtained in the simulator is different from the one that would be obtained for the same current state and action in the real world.

One can try to learn the difference between the two next states (sim and real) directly, using a regressor. This, however, suffers from inherent challenges. First, such a model cannot be applied easily to improve training, since setting the state of the simulator to a given value is inherently slow and makes training much less efficient. Second, the state is a partial depiction of reality. For example, it contains positions and speed, but not inertia. Inertia and other such factors are challenging to compute, given the randomization of mass and other factors in the simulation, tolerances in the manufacturing process, partial modeling due to the evolution of the robotic platform, unexpected inter-part effects in the robot that prevent part-by-part modeling, and variation in the behavior of each part by itself.

Furthermore, a state given by a regressor can be inconsistent with physics—the position and velocities along the kinematic chain can be incompatible with the chain's structure. Lastly, minimizing the discrepancy directly, using a given norm, does not bring the two environments (simulation and real-world) functionally closer. In other words, what matters is the way the robot walks and not some aggregated notion of matching simulation with reality.

### II. Related Work

The problem of closing the gap between simulation and the real-world is well known. Domain randomization that is, perturbing the simulator's parameters, such as the dynamics and terrains, is a common approach in legged robotics and RL-based robotics approaches. Since bipedal robots suffer from larger instability than quadrupeds, the sim2real gap is more prone to lead to failures, such as falling and braking. In contrast, the consequences of the sim2real gap are less harsh in dexterous robotics or in quadrupeds, and include, for example, a trajectory mismatch, which can be readily corrected in the following time steps.

In the field of dexterous robotics, several contributions modify the domain randomization distribution, also taking advantage of real-world data collected from the robot. A prominent line of work overcomes the computer vision aspects of the sim2real distribution, which is less relevant to our focus on control- and dynamics-based gaps.

Chebotar, Y., Handa, A., Makoviychuk, V., Macklin, M., Issac, J., Ratliff, N., and Fox, D. Closing the sim-to-real loop: Adapting simulation randomization with real world experience. In 2019 International Conference on Robotics and Automation (ICRA), pp. 8973-8979. IEEE, 2019 disclose SimOpt—that adapts the distribution of the simulator's parameters using several real-world data streams, such that the performance of policies in the simulation is more similar to the real-world behavior. SimOpt tries to minimize the distribution gap between partial observations induced by the trained policy and real-world observations.

Lim. V., Huang, H., Chen, L. Y., Wang, J., Ichnowski, J., Seita, D., Laskey, M., and Goldberg. K. Real2sim2real: Self-supervised learning of physical single-step dynamic actions for planar robot casting. In 2022 International Conference on Robotics and Automation (ICRA), pp. 8282-8289. IEEE, 2022 disclose Real2Sim2Real that is similar to SimOpt in that the method collects data from the real world in order to optimize simulation parameters. The differences between Real2Sim2Real and SimOpt are that (1) the optimization objective in Real2Sim2Real is defined as the L2 between real and simulated trajectories instead of the distribution gap between observations as in SimOpt, and (2) the simulator's parameters are optimized using Differential Evolution instead of RL. The tuned simulation is then used to generate synthetic samples, which are then used along with real-world data for training a new policy.

Du, Y., Watkins, O., Darrell, T., Abbeel, P., and Pathak, D. Auto-tuned sim-to-real transfer, 2021 IEEE International Conference on Robotics and Automation (ICRA), pp. 1290-1296. IEEE, 2021 discloses an autotuned Sim2Real method that trains both a policy and a second model that predicts whether each value out of a selected subset of system parameters is higher or lower in the simulation than the value that occurs in the real world. The simulation is then updated iteratively, based on real-world runs, improving the fit of the system parameters to the real world.

We note that SimOpt, Real2Sim2Real, and Autotuned Sim2Real were tested on object manipulation tasks, using a robotic arm.

In other settings, which are more stable, such as quadruped robotics, one can train directly in the real world.

Wu, P., Escontrela, A., Hafner, D., Abbeel, P., and Goldberg, K. Daydreamer: World models for physical robot learning. In Conference on Robot Learning, pp. 2226-2240. PMLR, 2023 disclose Day Dreamer which is a model-based RL approach that is applied to quadruped and dexterous robotics, by learning a world model from real data and using it for training the control network.

### SUMMARY

There may be provided a method for learning a bipedal robot control policy.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is an example of a method for learning a bipedal robot control policy;

FIG. 1B is an example of pseudo codes;

FIG. 2A is an example of a bipedal robot;

FIG. 2B. is an example of table 1 and table 2;

FIG. 3 illustrates a correction reward as a function of time;

FIG. 4 illustrates the symmetry score for real-world runs as a function of temporal cycles;

FIG. 5 illustrates the similarity between the action returned by the policy and the actual next state as a function of time;

FIG. 6 illustrates the similarity between the robot heading command and the obtained heading as a function of time;

FIG. 7 illustrates an example of a method;

FIG. 8 illustrates an example of a method;

FIG. 9 illustrates an example of a method; and

FIG. 10 illustrates an example of a system.

### DETAILED DESCRIPTION OF THE DRAWINGS

According to an embodiment, the illustrated solution is applicable to bipedal robots and may be regarded more critical to bipedal robots due to their inherent instability.

Nevertheless, the illustrates solution is applicable, mutatis mutandis to robots other than bipedal robots.

Any reference to a bipedal robot should be applied mutatis mutandis to a legger robot and/or should be applied mutatis mutandis to any other robot.

Due to the instability of inadequately controlled bipedal robots, bipedal walking policies need to be designed explicitly or learned offline in a simulator. The latter is subject to the simulation to real world (sim2real) gap, and the learned control policies suffer from a distribution shift. In this work, we overcome this shift by learning a corrective policy that modifies the actions such that the transition between time steps as provided by the physics simulator becomes closer to those observed in reality. This way, we can finetune the learned policy in an augmented framework in which the Sim2Real gap is reduced. We provide practical arguments and empirical results that show that an alternative method in which one learns to augment the next time step directly is much inferior to the action-space intervention we propose. Most importantly, the finetuned policies obtained with our method after completing the Sim2Real2Sim2Real deployment cycle improve along multiple characteristics, such as naturalness, stability, and adherence to control commands.

Instead of learning the transition error directly, we apply a novel strategy that modifies the transition from a state and an action to the next state by modifying the action. In other words, by modifying the actions taken in the simulator (but not in the real world) using a learned adapter, one can bring the two next states (the simulated and the real) closer together in a way that considers the evolution of the state over time. Simulation-based learning pipelines are designed to be conditioned on actions that are returned by a learned policy, and this intervention is readily trained and integrated, in contrast to the state-based approach described above.

Specifically, the learning problem of obtaining this action space adaptation is formulated as an RL problem that is learned in a simulator. We choose to apply an additive modification in the action space and the corrective policy we learn maps a tuple of the form (state, action) to a difference in the action space (more complex forms are just as easy to apply). This is similar to, but different from the walking policy that maps a state to an action.

Once the corrective term in the action space is learned, we can use it to learn or finetune a walking policy. This is done by passing to the simulator not the action that the learned policy outputs, but a modified action that is obtained by adding the output of the corrective policy.

The learned policy is then used back in the real world. This application is done without the correction term since its goal is to improve the sim2real match between the simulator and reality.

As our experiments show, our RL method is better able to minimize the gap between simulation and real-world than a supervised-learning baseline that minimizes the gap directly. Furthermore, the policy obtained by training in the modified simulation environment outperforms the policy trained, with exactly the same rewards, in the unmodified one.

We formulate the real-life physics and the simulator as Markov Decision Processes (MDPs)-M and \hat{M}, respectively.

M={A,S,P,u,r}, which stands for the action space A, the state space S, the state transition function P, the distribution of the initial states u, and the immediate reward r.

$$\hat{M} = ( A , S , \hat{P} , u , r \} .$$

The only difference between the MDPs is in the transition function between states. This choice is based on the assumption that the various discrepancies in modeling states and actions can be aggregated into the transition functions. The optimization process in all phases described below is performed using the Proximal policy optimization (PPO) algorithm. An example of the PPO algorithm is illustrated in J. Schulman, F. Wolski, P. Dhariwal, A. Radford, and O. Klimov, “Proximal policy optimization algorithms,” arXiv preprint arXiv: 1707.06347, 2017, which is incorporated herein by reference.

The first phase in our method consists of training a locomotion policy (also referred to as an initial control policy) in simulation, denoted ît.

This locomotion policy optimizes rewards such as adhering to commands, action regularization, and mimicking human-gait properties. An example of a locomotion policy is illustrated in J. Siekmann, Y. Godse, A. Fern, and J. Hurst, “Sim-to-real learning of all common bipedal gaits via periodic reward composition,” in 2021 IEEE International Conference on Robotics and Automation (ICRA). IEEE, 2021, pp. 7309-7315 which is incorporated herein by reference.

The method includes minimizing the gap between M and M by adding additive correction terms to the original actions.

Given a transition from the real world (s_t, a_t) to s_t+1 and a transition in the simulator (s_t, a_t) to ŝ_t+1, the goal of Itis to maximize the term e^{-∥ŝ}^{ₜ₊₁}^{-S}^{ₜ₊₁}^{∥}^{²} or simply put, minimize the squared error of the attained simulator state ŝ_t+1 given the previous baseline action a_t. This is done by modifying the baseline action.

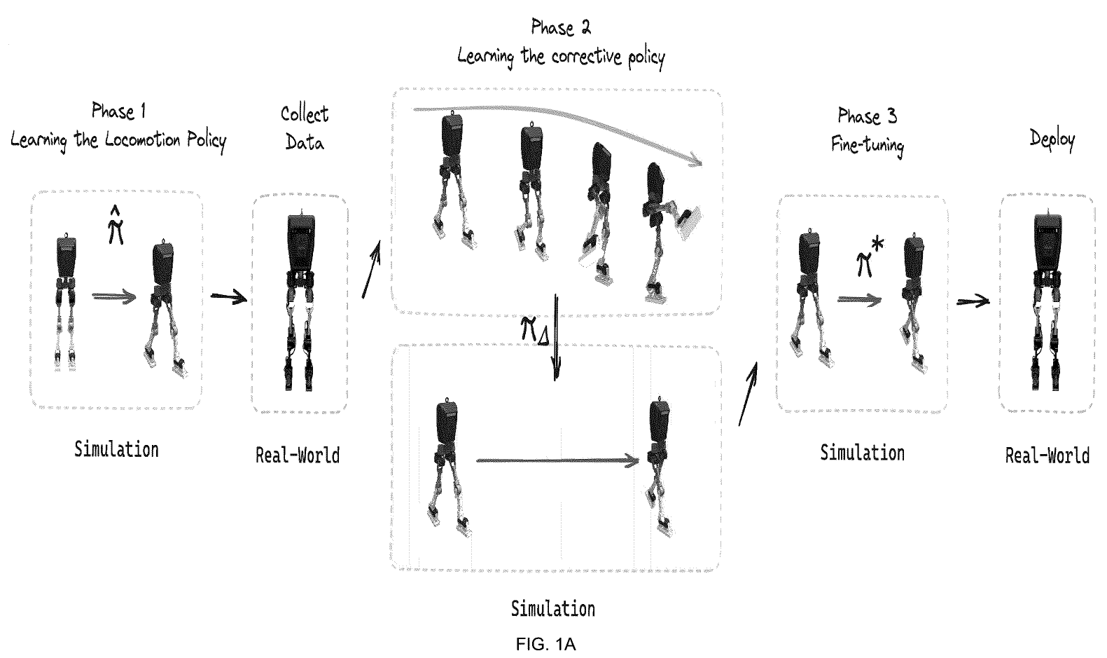

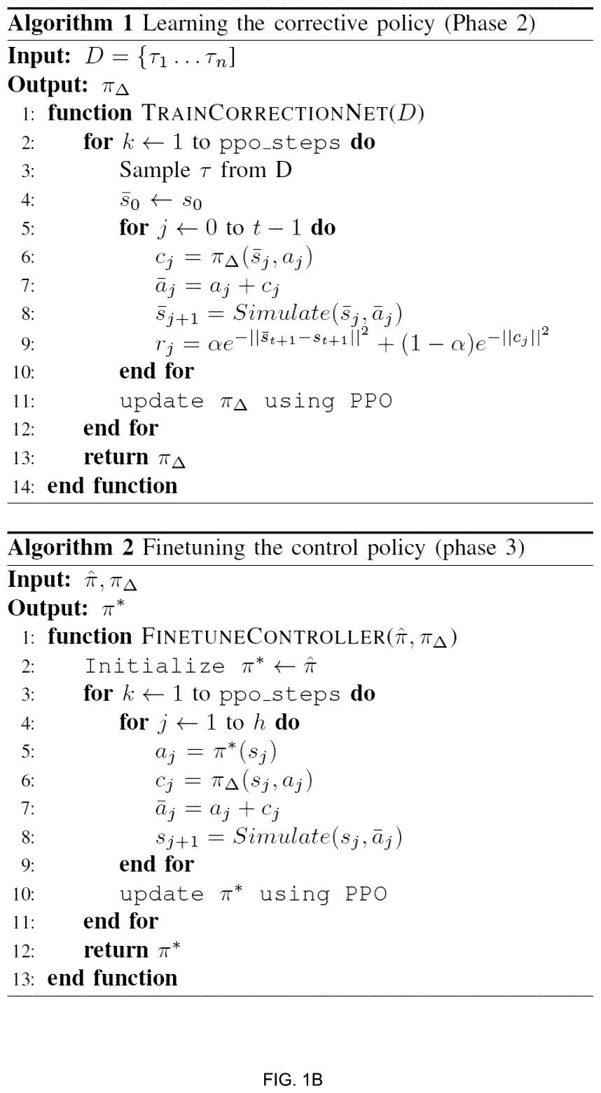

The last phase of our approach fine-tunes the initial policy \hat{π} in the simulator using the learned corrective policy π_{Δ}, to obtain π*, which is our final policy. An overview of the method is illustrated in FIG. 1A that shows the method and the flow between simulation and the real world.

The robot presented in the figure is our 12-DoF bipedal robot, see the experiments listed below for details.

### Phase 1—Learning the Locomotion Policy

In the first phase, we train a locomotion policy \hat{π} in the simulator. The state space S consists of q_pos in R\hat{ }12, q_vel in R\hat{ }12, which are the positions and velocities of the actuators, q_imu in R\hat{ }10, which represents the IMU readings, located at the pelvis of the robot, and cmd in R\hat{ }3, which are the requested linear velocity and target heading commands. Only proprioceptive sensors are used as inputs to the policy (except for the commands).

The action space A is the desired position of the different degrees of freedom sent to the robot's motors. The set of rewards includes not falling, walking at a certain periodic pace, retaining symmetry between leg movements, smoothness, and adherence to the heading command.

We employ several domain randomization techniques commonly used in the legged robotics—such as those illustrated in (i) J. Siekmann, K. Green, J. Warila, A. Fern, and J. Hurst, “Blind bipedal stair traversal via sim-to-real reinforcement learning,” in RSS, 2021, (ii) A. Kumar, Z. Li, J. Zeng, D. Pathak, K. Sreenath, and J. Malik, “Adapting rapid motor adaptation for bipedal robots,” in 2022 IEEE/RSJ International Conference on Intelligent Robots and Systems (IROS). IEEE, 2022, pp. 1161-1168 and/or (iii) I. Radosavovic, T. Xiao, B. Zhang, T. Darrell, J. Malik, and K. Sreenath, “Learning humanoid locomotion with transformers,” arXiv preprint arXiv: 2303.03381, 2023 which are incorporated herein by reference.

The domain randomization techniques are employed in order to increase the robustness of simulation to reality gaps. Without employing domain-randomization, effective policies cannot be learned, and we have invested considerable effort in developing the most effective randomization strategies, drawing heavily on the available literature. Specifically, we found that the most important randomization emerges from DoF properties, which essentially change the dynamic of the physical simulator. Additionally, it is crucial to randomize physical constants such as friction.

Using suitable domain randomization, the obtained control policy \hat{π} is able to walk in the real world. This policy is later used both as a base policy for fine-tuning π* and for data collection.

### Phase 2—Learning the Corrective Policy

In the second phase, we use the learned controller ît on the robot in a zero-shot setting-without training it on any real data. We collect trajectories of the form tau=(s_0, a_0, s_1 . . . , s_t−1, a_t−1, s_t).

By using this policy on the real robot. The commands used during these runs are given by a human controller as the robot walks around.

Given a data-set of such trajectories D={tau_1, tau_2, . . . , tau_n}, we train a new policy π_{Δ} to minimize the gap between M and \hat{M}.

During training, we initialize each actor by sampling a trajectory tau from D, and setting the actor's state in simulation to the same initial state s_0=(q_pos, q_vel, q_imu) as recorded in the real world.

Next, we load the matching action a_0 from tau, and pass the concatenation of (s_0, a_0) as an input to Its to obtain c_0, which is the correction term. Finally, the action passed to the simulation is â_0=a_0+c_0, and the new state attained from the simulation by transitioning from s_0 using actions â_0 is denoted as ŝ_1. This process is continued sequentially for all j=0 . . . ,t, where t is the last step of sample tau_i.

The reward we maximize is composed of two terms. The first is

$${R}_{c o r r e c t i o n} = {\sum }_{t a o ∈ D} {\sum }_{j = 0}^{t - 1} {e}^{- {‖ {\overline{s}}_{t + 1} - {s}_{t + 1} ‖}^{2}}$$

where, for brevity, we omit the index of tau since we do not mix between the trajectories. This reward compares the real state s {t+1} recorded from the robot directly to that attained from the simulator (with the modified action) s̅_{t+1} and minimizes their discrepancy.

The second term regularizes the outputs of the corrective policy:

$${R}_{r e g u l a r i z a t i o n} = {\sum }_{t a o ∈ D} {\sum }_{j = 0}^{t - 1} {e}^{- {‖ {c}_{j} ‖}^{2}}$$

The complete reward is:

$$R = alpha * ( R\_regularization + ( 1 - alpha ) * R\_correction$$

Alpha may be as a learned parameter with regularization with respect to its log value, as in A. Kendall, Y. Gal, and R. Cipolla, “Multi-task learning using uncertainty to weigh losses for scene geometry and semantics,” in Proceedings of the IEEE Conference on Computer Vision and Pattern Recognition (CVPR), June 2018. Which is incorporated herein by reference.

It is important to emphasize that during training we only reset the actor once, at the initialization step according to s_0, and do not repeat this for the next steps of the recorded trajectory.

While, as mentioned in Section I, the state vector carries only partial information about the environment, for the initial state s_0 we have prior knowledge that the robot was standing still with both feet on the ground, which allows for an accurate placement in simulation.

Algorithm 1 and algorithm 2 are pseudo codes that are included in FIG. 1B.

### Phase 3—Fine-tuning.

In the third phase, we use the learned corrective policy π_{Δ} and the simulator to fine-tune the original control policy \hat{π}. We will denote this new policy as π*.

The training of π* is similar in fashion to the first phase, the difference being that we use π_{Δ} with frozen parameters, in order to adjust the original simulation behavior by adding its correction terms to the actions computed by π*during the training period. Pseudo-code for this phase is provided in FIG. 1B.

### Deployment

Lastly, we use the finetuned policy π*on the real-world robot. Note that we do not make use of π_{Δ} or \hat{π}. The first is not needed, since the goal is to modify the transitions within the simulator, and the second has been finetuned and replaced by the policy π*.

### Experiments

In order to evaluate the performance of our suggested method, we split the evaluation process into two: (i) Evaluation of the corrective policy's ability to correct the simulation dynamics, and (ii) Evaluation of the controller that was fine-tuned with the corrective policy on the real robot.

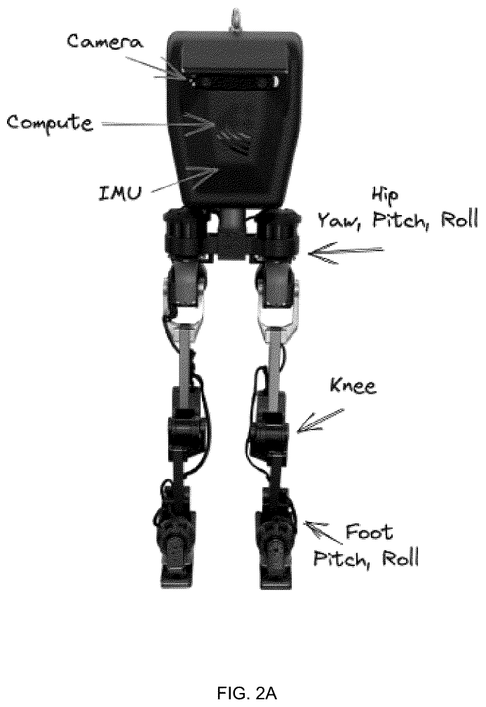

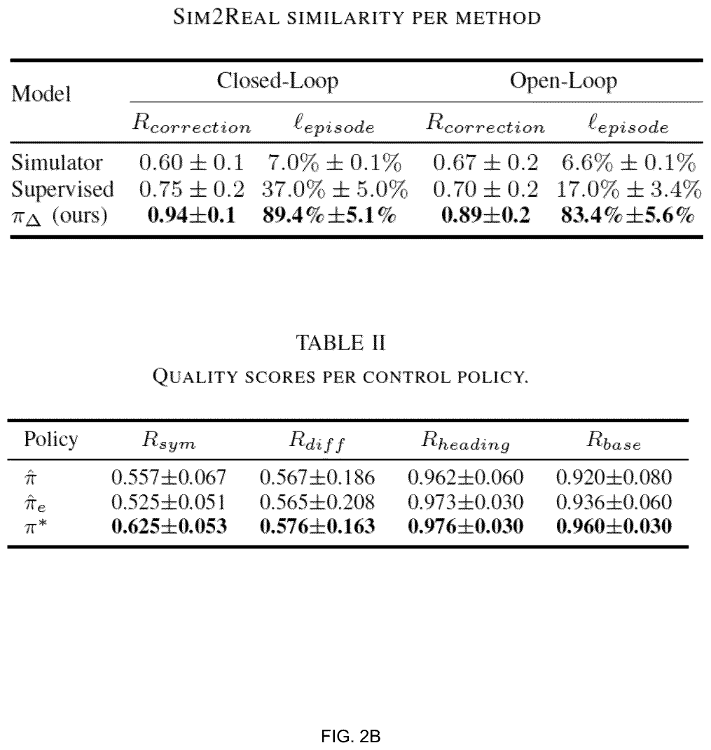

All of our real robot experiments are conducted on a bi-pedal robot, with 12 degrees of freedom in its legs, see FIG. 2A.

The actuator controllers are PD loops that convert the desired actuator positions to torques. The robot's height is 140 cm and it weighs 45 kg. The control gains were determined by a calibration process in which the tracking of the joint position in the simulation was optimized to match the real data. Two separate efforts to collect real-world data were conducted a month apart. In the first, used for training TA, trajectories from ten hours of walking were collected. In the second, used for the open-loop experiments below, three additional hours were collected.

The simulator used in this paper is the NVIDIA Isaac Gym simulator, as this simulator scales nicely with a large number of actors. The PyTorch infrastructure is used with the Adam optimizer (See D. P. Kingma and J. Ba, “Adam: A method for stochastic optimization.” in ICLR, 2015) which is incorporated herein by reference) and the architecture we use for the policy network is an LSTM with 2 layers, 512 hidden units each, that runs at 30 Hz. The training of policy \hat{π} (phase 1) took 40 hours. It took half as long to train the correction policy π_{Δ} (phase 2), and only 10 hours to train π* (phase 3). For a fair comparison, we report below also the results of a phase-1-like policy \hat{π}, which was trained for 120 hours.

### Sim2Real to Simulation

We first evaluate the ability of the corrective policy to reduce the dynamic gap between the simulation and reality. To do so, test trajectories of actions are recorded from runs of the trained policy \hat{π} on the real robot. The trajectory of actions is played with the same frame rate in the simulator environment, and the simulated observations are compared to the observations from the real trajectories.

We report the R_correction reward. In addition, a measure of the episode's length is given. This metric shows whether there is such a gap that the robot is unstable and falls in simulation. The episode length is given as a percentage of the episode length that the robot does not fall.

In all experiments, we compare (i) the ability of the physics simulator to replicate the same observations given the same actions, (ii) a supervised neural network with the same architecture as π_{Δ}, trained with an L2 loss on the regression task of predicting the gap between simulation observations and real observations, and (iii) our Δ_{π} network.

The first experiment is a closed-loop experiment, where the same trajectories are used for both training and testing, in a bootstrap manner. As Table 1 of FIG. 1B shows, while the unmodified simulator is unable to reproduce the real-data observations and, more importantly, is not accurate enough to maintain a stable robot, our method allows the simulator to replicate the same observations and for the robot to walk in a stable manner. Quite remarkably, a neural network of the same capacity, trained in a supervised manner to minimize the Sim2Real gap directly does not provide convincing results, even on the training set. Doubling the capacity of this network and searching for a better learning rate did not improve the scores, but we cannot rule out the possibility that one can find a better-fitting architecture.

The second experiment is a generalization experiment (open-loop), where different trajectories, collected after a month, were used for testing. This experiment is particularly interesting: if, rather than systematical gaps (such as latency, noise, hardware fault, etc.), the sim2real gap is the cause of physical modeling gaps, then the corrective policy, π_{Δ}, may be able to generalize to unseen examples as well.

The results of the open-loop experiment are also provided in Table 2 of FIG. 2B. Evidently, our method is able to generalize to different unseen trajectories, minimizing the Sim2Real gap. Since the vanilla simulator does not change between the open and closed-loop experiments, it is expected that the results would be similar. The supervised network is unable to generalize well, with a more than 20% drop in the length of episode due to unseen trajectories. These results emphasize the need for RL when modeling complex dynamics, such as in physical simulators, and especially for bipedal locomotion.

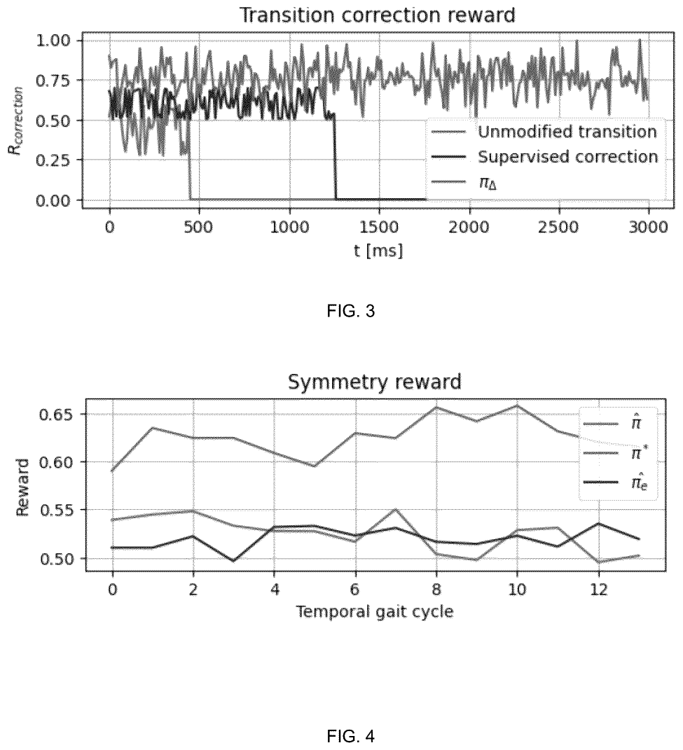

FIG. 3 depicts a typical run of the same logged sequence of actions generated from policy \hat{π}, played out in the simulator environment. When the sim2real correction policy π_{Δ} is applied, the robot maintains locomotion for the entire trajectory without falling. For both the unmodified transition and the one learned in a fully supervised manner, the robot falls much sooner. There is also a clear advantage in terms of R_correction, which is much higher for the π_{Δ} than for the other two options.

### Sim2Real2

The evaluation of both the conventionally trained policy \hat{π} and our full method's policy π* is done via the computation of multiple scores on real data trajectories collected using our robot. For a fair comparison, we add an additional baseline policy, \hat{π}_e, which is the policy \hat{π} further trained for the same additional time as the finetuning step of phase 3 for π*. We note that both \hat{π} and \hat{π}_e are trained after investing considerable effort into finding an effective training procedure and domain randomization strategy. Therefore, these policies represented the state-of-the-art in the domain of RL-based bipedal locomotion.

The first score is the symmetry reward, R_sym. This reward corresponds to the distance between the current DoF positions and the mirrored DoF positions half a clock cycle earlier. This distance shows how well-behaved the policy is, maintaining a constant rhythm of walking while correcting the posture of the robot fast enough to conserve symmetry with respect to a half-cycle shift.

$${R}_{s y m} ( t ) = exp ( - {‖ mirror ( {s}_{t - ( \frac{T}{2} )} ) - {s}_{T} ‖}^{2} )$$

where, T is the cycle duration, and mirror(s) is a function that computes the laterally inverted positions of the DoF. As can be seen in FIG. 4, the symmetry obtained by our method outperforms the two baseline policies.

Our method's policy is able to sustain the high physical impact of walking, and correct the robot's DOF positions in order to comply with the desired symmetry reward.

The second score is the difference between the action given by the policy and the actual measured position in the consecutive time step. It is expected that a policy trained with minimal sim2real gap will have lower differences and the robot will be able to perform the action effectively.

The difference score, R_diff is defined as:

$${R}_{diff} ( t + 1 ) = exp ( - {‖ {q}_{p o {s}_{{s}_{t + 1}}} - {a}_{t} ‖}^{2} )$$

where q_pos_s_t+1 are the actuators' positions in the observed state at time step t+1, and a_t is the action returned by the policy at the previous time step.

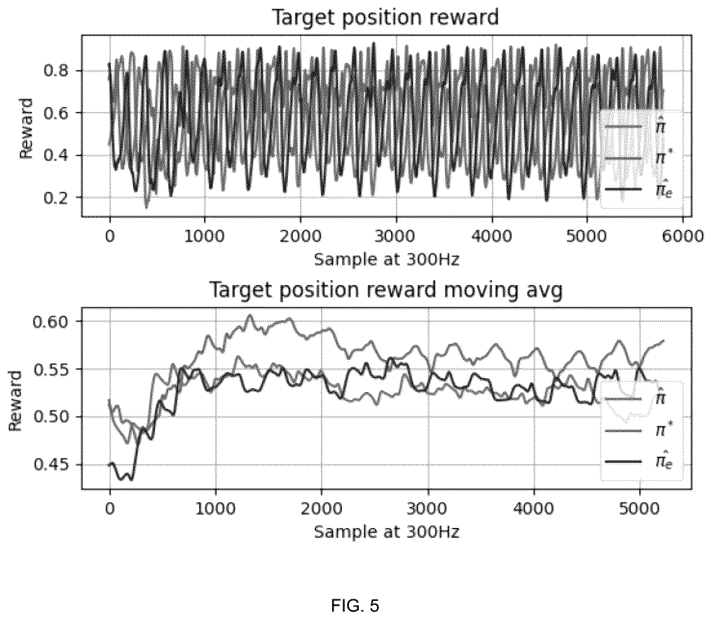

As can be seen in FIG. 5, depicts the similarity between the actions and the actual state obtained in the consecutive time step. Since all policies show a periodic pattern, which is produced by the control loop (moving between undershooting and overshooting), a moving average is also provided. Our final policy π*, produces a sequence of actions such that the obtained similarity is considerably higher. In the case of π* the match between the action and the state obtained at the peaks is considerably better.

The third score we measure is the robot's heading h_t adherence to the target heading, provided by the user command cmd, using the following score:

$${R}_{heading} ( t ) = exp ( - {‖ {h}_{t + 1} - c m {d}_{t} ‖}^{2} )$$

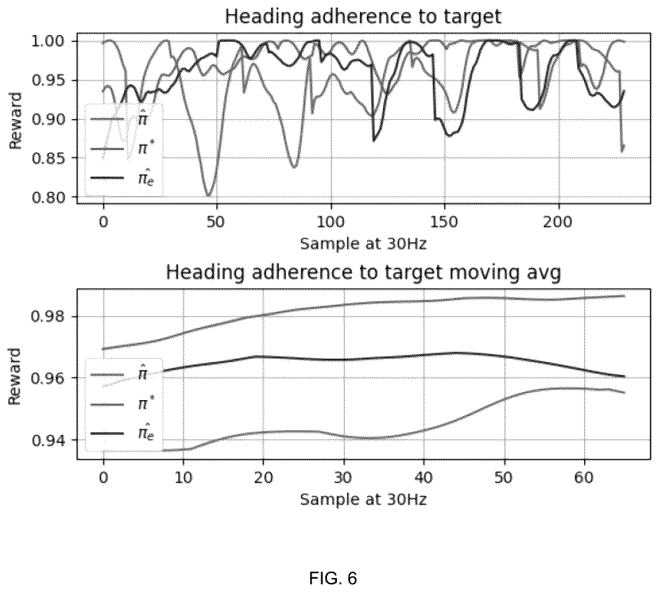

As shown in FIG. 6 for a typical run, our policy π* outperforms the baselines for this score as well.

Lastly, we measure how leveled the base link is, by comparing the orientation b_t of the baseline at time t to the upright direction u.

$${R}_{b a s e} ( t ) = exp ( - {‖ {b}_{t} - {u}_{t} ‖}^{2} )$$

Unless the robot is turning, we expect its pelvis to remain upright during most of the walk in a natural gait. While some pelvis motion can add to the naturalness and efficiency of the walking pattern, it is usually much more subtle than that observed in flawed walking.

A summary of the scores on a set of ten runs per policy is provided in Table 3. As can be seen, in all four scores, our final policy π* outperforms the baselines. Further training \hat{π} to obtain \hat{π}_e helps in two out of the four metrics, however, not as much as running our full method.

### DISCUSSION

The task of walking a bipedal robot is challenging, due to the nature of the task. The dynamics of walking, which involve falling forward, are such that only a tiny subset of the trajectories one can take in the heading direction is not disastrous to the surroundings and to the robot itself. To add to the challenge, the task cannot be defined directly, and one is required to combine and balance multiple rewards.

In contrast, for dexterity tasks in robotics, the desired outcome is easier to formulate.

To add to the challenge, measuring the quality of bipedal walking is not trivial and it involves multiple conflicting and softly defined aspects. Specifically, the rewards used during training provide only a partial view of what it means to walk effectively and efficiently.

These challenges imply that the task is incompatible with on-policy training in the real world. They also imply that the reward computed in the simulator may not be relevant to real-world behavior, due to the drift in the behavior of the policy caused by the sim2real effect. In particular, the delicate art of reward engineering and reward balancing may become futile when moving to the real world, due to changing statistics.

Therefore, minimizing the Sim2Real gap is extremely important for being able to improve a walking gait learned in a simulator with real data. In Section I we specify practical reasons why one cannot simply augment the simulator with a prediction of the Sim2Real error. Later on, in Section IV, we further show that the supervised learning problem is not trivial to learn, or at least requires more capacity and effort than our method.

In contrast, our action-space adapter network integrates into the simulator naturally, employs similar RL training practices to the training of the control policy, and can be readily applied for finetuning the control policy.

A limitation of our method is that since learning occurs in the context of a specific policy, it is not clear whether it would minimize the sim2real gap in the context of other policies. This is easy enough to check but was not done in time for the submission deadline.

Another point that was not explored enough is whether the action space adapter influences the nature of the finetuned policy. For example, it may lead to the policy showing a preference for actions that lead to predictable results, which may act as a new form of regularization and be beneficial or, conversely, too limiting.

### Discussion and Limitations

The presented method for reducing the Sim2Real gap is applicable only once a good enough controller is available. Before that point, no relevant data can be collected. Of course, obtaining a sufficiently effective initial policy requires one to tackle Sim2Real issues beforehand, which is not trivial.

Assuming one passes this threshold, there are not many good alternatives for utilizing the real-world data one can then gather. As discussed above, alternative methods focus on tuning the simulation parameters to fit the real world, while we do not assume that such an adjustment is possible. These methods were not tested for legged locomotion.

Inspired by these methods, we made attempts to use regression to recover a set of parameters in the range that we randomized over, based on a straightforward collection of simulator data. Despite best efforts and various sanity checks of the obtained parameters, using the estimated parameters did not lead to better performance. Naturally, this does not preclude the possibility that such an approach would be beneficial. However, it does highlight the elegance of our method, in which π_{Δ} has exactly the same architecture and training procedure as \hat{π}.

Admittedly, the requirement to conduct experiments on a real robotic system means that the scope of our experiments is limited to a single system. While we have provided four distinct and meaningful quality scores, more can be added, e.g., the behavior under load or external forces.

Realistically, one cannot move between the simulator and the real world more than a few times. Therefore, the data collected in the real world should be used to reduce the sim2real gap directly, enabling better training. In previous work, this was done by recovering key parameters of the simulation or the virtual model. However, it is not clear whether one can close all gaps by tuning such parameters.

In our work, we propose to minimize the discrepancy of the transition function between the simulation and the real world. As we demonstrate, one cannot learn the error in the transition function directly and even if this were possible, it would not readily integrate into the simulator. Instead, we modify the transition function of the simulator, by learning an adapter in the action space.

The training of this adapter is performed using the same RL tools that are used to optimize the control policy itself, in an offline manner, based on real-world data that is straightforward to collect. As we show, training a control policy using the modified action space leads to markedly better robot locomotion.

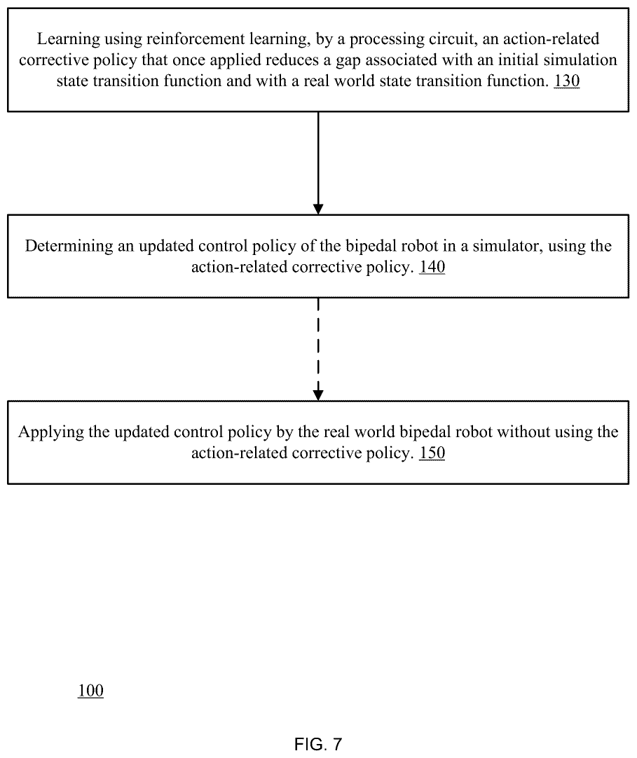

FIG. 7 illustrates an example of method 100 for learning a control policy.

According to an embodiment the control policy is a bipedal robot control policy, a legged robot control policy or a control policy applicable to any other robot.

According to an embodiment, method 100 includes step 130 of learning using reinforcement learning, by a processing circuit, an action-related corrective policy that once applied reduces a gap associated with a first simulation state transition function and with a real world state transition function.

According to an embodiment, step 130 includes determining the gap by comparing the first simulation state transition function to the real world state transition function.

According to an embodiment, the first simulation state transition function is included in a simulation Markov decision process (MDP) associated with the robot being simulated in the simulator.

According to an embodiment, step 130 includes applying a corrective reward and a regularization reward. See, for example, R_{correction} and R_{regularization}.

According to an embodiment, step 130 is followed by step 140 of determining a second control policy of the robot in a simulator, using the action-related corrective policy.

According to an embodiment, step 140 is followed by step 150 of applying the second control policy by the real world robot without using the action-related corrective policy.

It should be noted that step 150 is optional and/or may be applied by a real world robot that did not execute any step of 130 and 140.

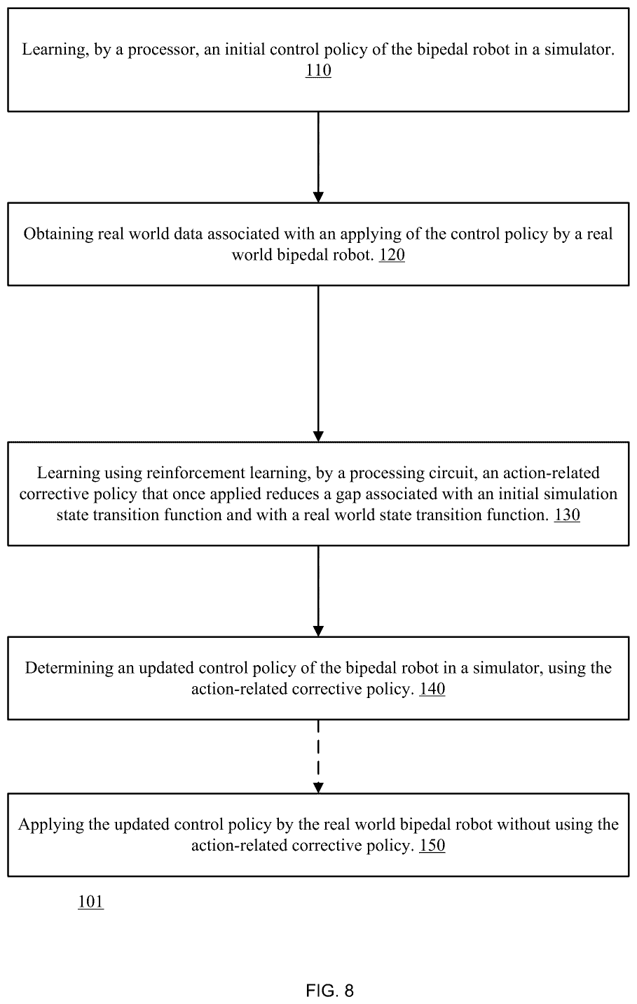

FIG. 8 illustrates an example of method 101 for learning a robot control policy.

According to an embodiment, method 101 includes step 110 of learning, by a processor, a first control policy of the bipedal robot in a simulator. The first control policy is indicative of a first simulated state transition function.

According to an embodiment, the first control policy is an initial control policy. It is termed an initial because the control policy differs from the second policy which is the control policy that is to be used by the robot.

According to an embodiment, step 110 involves applying reinforcement learning.

According to an embodiment, step 110 is followed by step 120 of obtaining real world data associated with an applying of the control policy by a real world robot: the real world data is indicative of the real world state transition policy.

According to an embodiment, step 120 includes applying the control policy by the real world robot.

According to an embodiment, the applying of the control policy by the real world robot is executed in a zero-shot setting.

According to an embodiment, step 120 is followed by step 130 of learning using reinforcement learning, by a processing circuit, an action-related corrective policy that once applied reduces a gap associated with an initial simulation state transition function and with a real world state transition function.

According to an embodiment, step 130 is followed by step 140 of determining a second control policy of the robot in a simulator, using the action-related corrective policy.

According to an embodiment, step 140 includes fine tuning the first control policy.

According to an embodiment, the fine tuning includes using the action-related corrective policy with frozen parameters.

According to an embodiment, step 140 is followed by step 150 of applying the second control policy by the real world robot without using the action-related corrective policy.

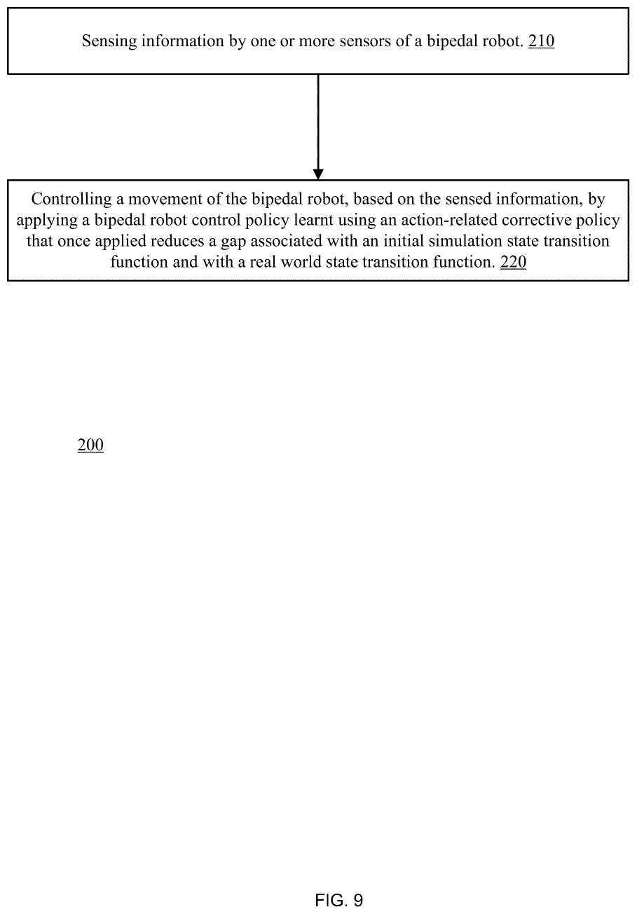

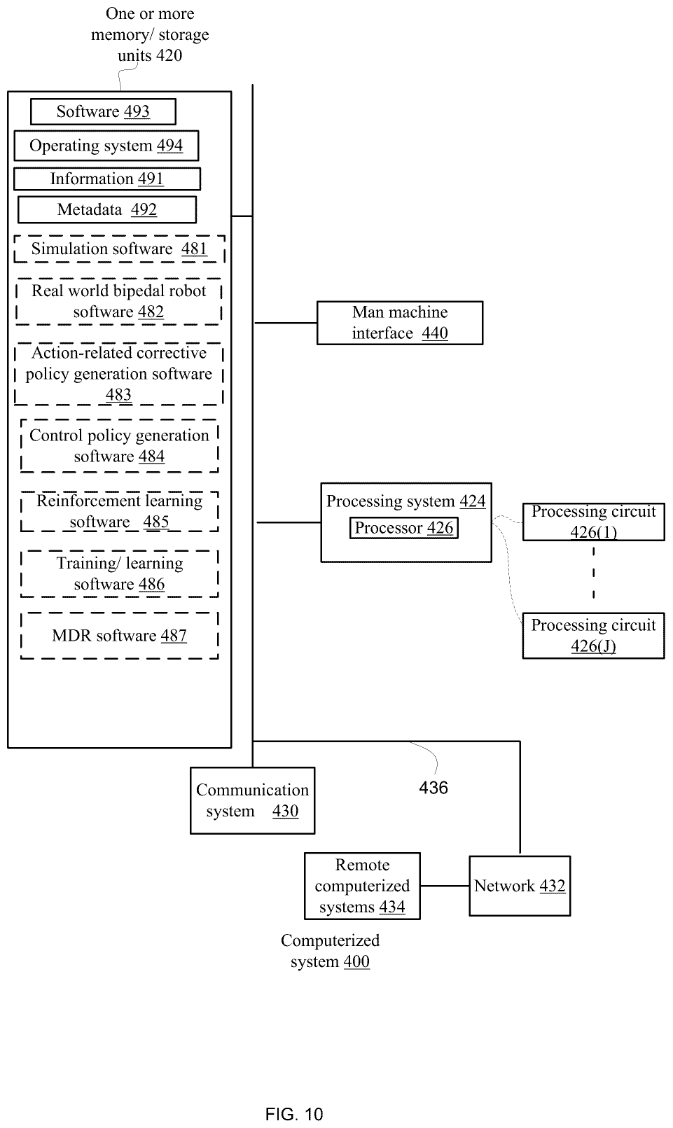

FIG. 9 is an example of a method 200 for controlling a robot.

According to an embodiment, method 200 includes step 210 of sensing information by one or more sensors of a robot.

According to an embodiment, step 210 is followed by step 220 of controlling a movement of the robot, based on the sensed information, by applying a second control policy learnt using an action-related corrective policy that once applied reduces a gap associated with an initial simulation state transition function and with a real world state transition function.

According to an embodiment, the second control policy is the updated robot control policy learnt by method 100 and/or method 101.

According to an embodiment, step 220 is also based on instructions provided to the robot-such as a target location, a path, a mission that requires movement, and the like.

FIG. 11 illustrates a computerized system 400 configured to execute one or more steps of method 100 and/or method 101.

A processing system 424 includes a processor 426 that includes a plurality (J) of processing circuits 426(1)-416(J) that include one or more integrated circuits and/or are included in one or more integrated circuits.

The processing circuit is in communication (using bus 436) with communication system 430, man machine interface 440 and one or more memory and/or storage units 420 that stores software 493, operating system 494m information 491 and metadata 492 for executing one or more steps of method 100 and/or method 101.

According to an embodiment the software includes one of more of simulation software 481 for performing simulations-especially any phase of the mentioned above methods that is related to simulation, real world bipedal robot software 482 for obtaining real world information, action-related corrective policy generation software 483 for determining the action-related corrective policy, control policy generation software 484 for generating the control policy and/or for generating the initial control policy, reinforcement software 485 for performing any step or phase related to reinforcement learning, training and/or learning software 486 for performing any training and/or learning, MDR software 487 for generating one or more MDRs, and/or for comparing between MDRs.

The communication system 430 is in communication via network 432 with remote computerized systems 434 such as one or more bipedal robots, or other computerized systems.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using mechanical components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and/or should be applied mutatis mutandis to a computer readable medium that stores instructions for executing the method.

Any reference in the specification to a system should be applied mutatis mutandis to a method that may be executed by the system and/or should be applied mutatis mutandis to a computer readable medium that stores instructions executable by the system.

Any reference in the specification to a computer readable medium that stores instructions should be applied mutatis mutandis to a system capable of executing the instructions and/or should be applied mutatis mutandis to a method executable by the instructions.

Any reference to “comprising” or “having” may be applicable, mutatis mutandis, to “consisting essentially of.” Any reference to “comprising” or “having” may be applicable, mutatis mutandis, to “consisting of.”

Any reference to a “processor” is applicable mutatis mutandis toa processing circuit and/or applicable mutatis mutandis to a computerized system.

According to an embodiment, a processing circuit and/or a processor are hardware elements such as but not limited to machine learning processors, neural network processors, graphic processing units, integrated circuits or portion thereof, field programmable gate array processing circuits, application specific integrated circuits, and the like.

While one or more examples of the forgoing specification referred to controlling a movement of an entirety of a robot, the controlling is applicable, mutatis mutandis to movement of only some movable elements of the robot-such as arms, and the like.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units, or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for learning a robot control policy, the method comprising:
learning using reinforcement learning and by a processing circuit, an action-related corrective policy that once applied reduces a gap associated with an initial simulation state transition function and with a real world state transition function; and
determining a control policy of the robot in a simulator, using the action-related corrective policy.

2. The method according to claim 1, comprising determining the gap by comparing the initial simulation state transition function to the real world state transition function.

3. The method according to claim 1, wherein the learning of the action-related corrective policy comprising applying a corrective reward and a regularization reward.

4. The method according to claim 1, further comprising applying the control policy by the real world robot without using the action-related corrective policy.

5. The method according to claim 1, wherein the learning of the action-related corrective policy is preceded by:
learning, by a processor, an initial control policy of the robot in a simulator; the initial control policy is indicative of the initial simulated state transition function; and
obtaining real world data associated with an applying of the initial control policy by a real world robot: the real world data is indicative of the real world state transition policy.

6. The method according to claim 5, wherein the learning of the initial control policy involves applying reinforcement learning.

7. The method according to claim 5, comprising applying the initial control policy by the real world robot.

8. The method according to claim 7, wherein the applying of the initial control policy by the real world robot is executed in a zero-shot setting.

9. The method according to claim 5, wherein the determining of the control policy comprises fine tuning the initial control policy.

10. The method according to claim 9, wherein the fine tuning comprises using the action-related corrective policy with frozen parameters.

11. The method according to claim 1, wherein the robot is a bipedal robot.

12. The method according to claim 1, wherein the robot is a legged robot.

13. A non-transitory computer readable medium for learning a robot control policy, the non-transitory computer readable medium stores instruction executable by a processing unit for:
learning using reinforcement learning and by a processing circuit, an action-related corrective policy that once applied reduces a gap associated with an initial simulation state transition function and with a real world state transition function; and
determining a control policy of the robot in a simulator, using the action-related corrective policy.

14. The non-transitory computer readable medium according to claim 13, further storing instruction executable by a processing unit for determining the gap by comparing the initial simulation state transition function to the real world state transition function.

15. The non-transitory computer readable medium according to claim 13, wherein the learning of the action-related corrective policy comprising applying a corrective reward and a regularization reward.

16. The non-transitory computer readable medium according to claim 13, further storing instruction executable by a processing unit for applying the control policy by the real world robot without using the action-related corrective policy.

17. The non-transitory computer readable medium according to claim 13, wherein the learning of the action-related corrective policy is preceded by:
learning, by a processor, an initial control policy of the robot in a simulator; the initial control policy is indicative of the initial simulated state transition function; and
obtaining real world data associated with an applying of the initial control policy by a real world robot; the real world data is indicative of the real world state transition policy.

18. A method for controlling a robot, the method comprising:
sensing information by one or more sensors of the robot; and
controlling a movement of the robot, based on the sensed information, by applying a robot control policy learnt using an action-related corrective policy that once applied reduces a gap associated with an initial simulation state transition function and with a real world state transition function.

19. The method according to claim 18, comprising learning, using reinforcement learning, the action-related corrective policy.

20. A non-transitory computer readable medium for controlling a robot, the non-transitory computer readable medium stores instruction executable by a processing unit for:
sensing information by one or more sensors of the robot; and
controlling a movement of the robot, based on the sensed information, by applying a robot control policy learnt using an action-related corrective policy that once applied reduces a gap associated with an initial simulation state transition function and with a real world state transition function.
